(19) United States
(12) Patent Application Publication
(10) Pub. No.: US 2010/0092241 A1
(43) Pub. Date: Apr. 15, 2010

(54) Canal Seepage Detection

(76) Inventor: Muhammad Arshad, Islamabad (PK)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/577,962

(22) Filed: Oct. 13, 2009

Related U.S. Application Data
(60) Provisional application No. 61/104,909, filed on Oct. 13, 2008.

(51) Int. Cl. E02B 13/00; G06K 9/00

(52) U.S. Cl. 405/52; 382/108

(57) ABSTRACT

The present invention discloses how irrigation canal seepage can be reduced. Such reduction can be accomplished by obtaining aerial data of an irrigation canal obtained with the use of an aerial image acquiring unit, identifying a water body from the aerial image, analyzing water pixel brightness values of the water body to discern water disturbances indicative of water seepage, and outputting the location of the water seepage site on a two-dimensional or three dimensional display.

### CROSS-REFERENCE TO RELATED APPLICATIONS

This application claims the benefit of U.S. Provisional Application No. 61/104,909, filed Oct. 13, 2008, entitled “Improving the Accuracy of Canal Seepage Detection Through Geospatial Techniques,” which is hereby incorporated by reference in its entirety.

### BRIEF DESCRIPTION OF THE SEVERAL VIEWS OF THE DRAWINGS

FIG. 1 is a block diagram illustrating aspects of an embodiment of an irrigation canal seepage detection system.

FIG. 2 is a block diagram illustrating aspects of an embodiment of an irrigation canal seepage detection system that further includes an Arial image database.

FIG. 3 is a block diagram illustrating aspects of an embodiment of an irrigation canal seepage detection system that further includes an image processing device.

FIG. 4 is a block diagram illustrating aspects of an embodiment of an irrigation canal seepage detection system that further includes an image preprocessor.

FIG. 5 is a flow chart illustrating an embodiment of a process for reducing irrigation canal seepage.

FIG. 6 is a flow chart illustrating possible actions that can be taken for preprocessing an image.

FIG. 7 is a flow chart illustrating an embodiment for masking interfering features.

FIG. 8 is a flow chart of the method used to determine if the pattern of water pixel brightness values indicates a seepage or non-seepage site.

FIG. 9A is a pattern of temperature gradients at non-seepage sites.

FIG. 9B is an example schematic of brightness values for non-seepage sites.

FIG. 10A is an example schematic of temperature gradients at seepage sites.

FIG. 10B is an example schematic of brightness values for seepage sites.

FIG. 11 is a set of aerial data which shows seepage or a canal breach in brightness values.

### DETAILED DESCRIPTION OF EMBODIMENTS

Several embodiments will now be described in detail with reference to the accompanying drawings. It should be understood that the embodiments and the accompanying drawings have been described for illustrative purposes, and the present invention is limited only by the claims.

The embodiments of this invention relate generally to systems and methods for reducing irrigation canal seepage. Certain embodiments relate to systems and methods for identifying canal seepage sites by using aerial imaging and then modifying the area of the canal where water seepage is identified.

Various terms used herein may be defined as follows.

“Modifying” refers to, but not limited to, (1) replacing a section of a canal where canal seepage is detected; (2) lining the canal with asphalt, geomembranes, concrete, puddle clay, or bentonite; and (3) using other construction materials that improve water retention and water seepage reduction.

“Remote sensing” is the use of aerial or satellite imaging to collect information from areas of interest (e.g., canals, vegetation, soil, minerals, oceans, etc.) in a region of a planet's surface for further and/or future analysis by electronic sensors or other types of devices.

“Pixel” is an abbreviation for picture element. “Pixel” as used in this specification, refers to the smallest unit of light information within an image that is displayable on an electronic screen (such as a video screen) or transferable to physical media (such as a hard copy print of a digital image).

As one embodiment, the present invention teaches a method for reducing irrigation canal seepage. This method involves: (1) obtaining aerial data of an irrigation canal by using an aerial image acquiring unit; (2) identifying at least one water body that is captured in the aerial data; (3) analyzing water pixel brightness values of the water body to discern water disturbances that are indicative of water seepage; and (4) outputting on a display, the location of at least one of the water bodies if the water body was determined to have a water disturbance that is indicative of water seepage.

At least some of the aerial data includes at least one aerial image. The aerial image may include pixel brightness values.

The display may be a two-dimensional display or a three-dimensional display that can also show temporal data that is either delayed or in real-time. Alternatively, the display may be a four-dimensional display.

In another embodiment, the method further includes modifying an area of the canal where water seepage is identified.

In yet another embodiment, the method further includes (1) correcting the aerial data by using a geometric distortion processor; and (2) mosaicking a set of the aerial image. This set includes at least two images, which may be called a first image and a second image. It is possible that the first image has a section that overlaps the second image. This section may be called an overlapping area.

In yet another embodiment, the method further includes masking the aerial image to remove at one interfering feature. Such masking feature may additionally remove a first class of false impressions by limiting the aerial image to a first predetermined bandwidth. Furthermore, the masking feature further comprises removing a second class of false impressions by limiting the aerial image to a second predetermined bandwidth. For both the first predetermined bandwidth and the second predetermined bandwidth, examples of bandwidth include, but are not limited to, 1 nm, 10, nm, 20, nm, 25 nm, 50 nm, 100 nm, 150 nm, etc.).

In yet another embodiment, the first class of false impressions includes vegetation.

In yet another embodiment, the second class of false impressions includes one or a combination of the following: man-made objects, roads, and buildings.

In yet another embodiment, where the present invention identifies the water body captured in the aerial data, this identification aspect includes using at least one seepage processor to discriminate differences between seepage sites and non-seepage sites.

In yet another embodiment, where the present invention analyzes the pixel brightness values of the water body to discern water disturbances that may be indicative of water seepage, the present invention uses at least one analyzing processor to perform the analysis on seepage sites and non-seepage sites.

As another embodiment, the present invention teaches an irrigation canal seepage detection system.

The system is designed to operate on a personal computer (PC). However, as another embodiment, the system is also of a modular design that can be used in an enhanced computing environment, such as a multithreaded processing environment, a multi-processor computer, a parallel processing computer, a computer having multiple logical partitions, or by distributed processing methods in which the system's processes are divided between many computers communicating over a network, such as the Internet.

Such system is made up of the following configurable, hardware modules: (1) at least one aerial image acquiring unit; (2) at least one water body identification module; and (3) at least one irrigation canal seepage detection processor. The aerial image acquiring unit can be configured to form at least one aerial image of the canal using at least one predetermined bandwidth. The aerial image includes at least one water pixel brightness value. The water body identification module can be configured to detect the location of at least one water body (e.g., streams, creeks, rivers, ponds, lakes, bays, seas, oceans, etc.). The irrigation canal seepage detection processor can be configured to detect irrigation canal seepage by analyzing water pixel brightness values of the water body to discern water disturbances that are indicative of water seepage.

The system can further include additional configurable, hardware modules. One example is a data preprocessing module. Another example is an interfering feature module.

The data preprocessing module can be configured to correct geometric distortions in at least one of the aerial images. Additionally, the data preprocessing module can be configured to create at least one mosaic image by mosaicking a set of the aerial image. The set can include at least a first image and a second image. The first image may have a section that overlaps the second image. Such section may be called an overlapping area.

In another embodiment, the interfering feature module can be configured to mask at least one interfering feature.

In another embodiment, the predetermined bandwidth is selected to minimize the effect of at least one or a combination of the following on the aerial image: (1) vegetation; (2) man-made objects; (3) roads; and (4) buildings.

In yet another embodiment, the aerial image acquiring unit acquires images from at least one online aerial image database. An example of the aerial image database is Google Earth.

In yet another embodiment, the aerial image acquiring unit is attached onto at least one air vehicle, such as a plane, helicopter, hot air balloon, etc. “Attached”, in this sense, means being embedded, connected (whether wired or wireless), mounted, part of, etc.

In yet another embodiment, the irrigation canal seepage detection processor compares the aerial image to at least one reference image, which may be stored in a database.

In yet another embodiment, the reference image should be substantially optically equivalent to the image of the aerial image. Furthermore, the reference image comprises designations that identify seepage sites and non-seepage sites of the canal.

In yet another embodiment, the irrigation canal seepage detection processor is further configured to indicate where seepage sites are located.

As yet another embodiment, the present invention teaches a computer-readable storage medium. Examples of the computer-readable storage medium include, but are not limited to, a compact disc (cd), digital versatile disc (dvd), usb flash drive, floppy disk, random access memory (RAM), read-only memory (ROM), erasable programmable read-only memory (EPROM), optical fiber, etc. It should be noted that the computer-readable storage medium may even be paper or other suitable medium in which the instructions can be electronically captured, such as optical scanning. Where optical scanning occurs, the instructions may be compiled, interpreted, or otherwise processed in a suitable manner, if necessary, and then stored in computer memory.

The instructions may be written using any computer language or format. Nonlimiting examples of computer languages include Ada, Ajax, C++, Cobol, Java, Python, XML, etc.

The computer-readable storage medium is a physical and tangible item that can store a program of instructions that are executable by a computer to perform the above method of reducing irrigation canal seepage. The method includes: (a) obtaining aerial data of an irrigation canal by using an aerial image acquiring unit; (b) preprocessing the aerial data by using a geometric distortion processor; (c) using at least one identification module to identify at least one water body captured in the aerial data; (d) analyzing, with at least one irrigation canal seepage processor, water pixel brightness values of the water body to discern water disturbances that may be indicative of water seepage; and (e) outputting, on a display, the location of at least one of the water body if the water body is determined to have a water disturbance that is indicative of water seepage.

In yet another embodiment, at least some of the aerial data includes at least one aerial image. The aerial image may include pixel brightness values.

In yet another embodiment, the display is either a two-dimensional or three-dimensional display. Each of both types of displays can incorporate temporal data that is either delayed or in real-time. Alternatively, the display may be a four-dimensional display.

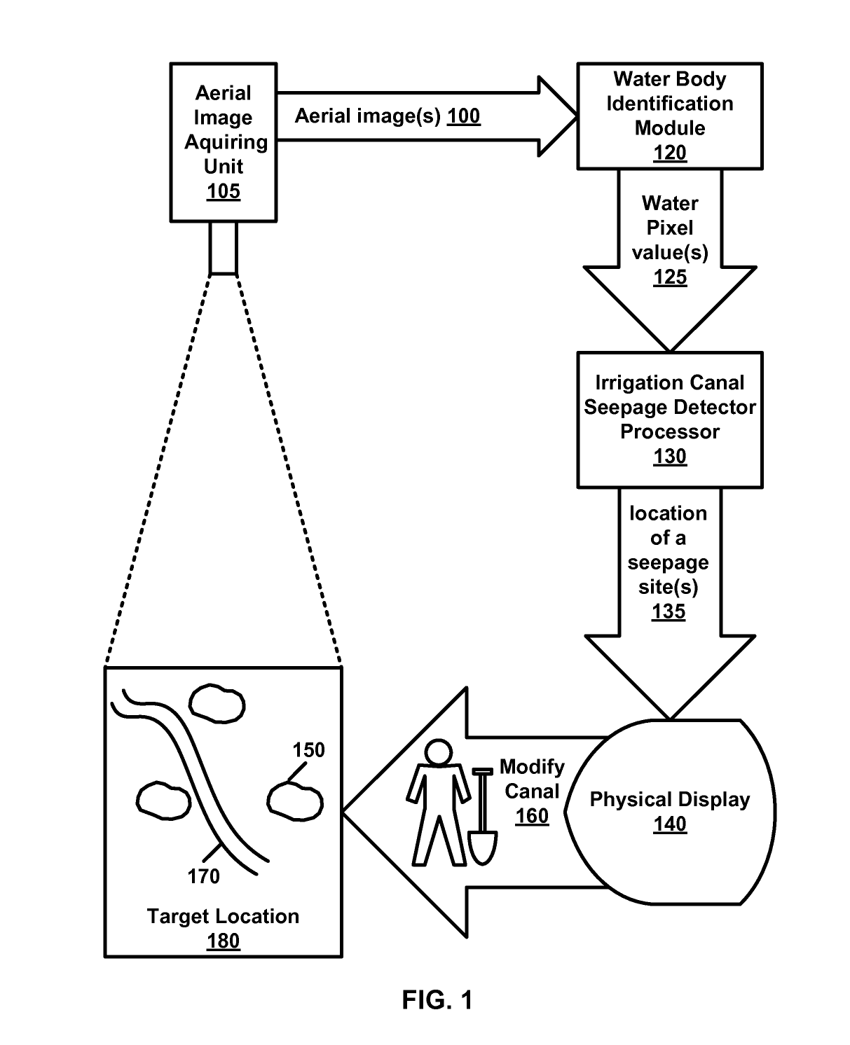

Referring to the figures, FIG. 1 is a flow chart illustrating a first embodiment of an irrigation canal seepage detection system. Aerial images 100 of a target location 180 are obtained using an aerial image acquiring unit 105. A water body identification module 120 then identifies at least one water body. Water pixel brightness values 125 of a water body are then processed in an irrigation canal seepage detector processor 130. The irrigation canal seepage detector processor 130 then analyzes the pattern of the water pixel brightness values and reports the location of a seepage site 135 on a physical display 140. Finally, a segment or area of the canal is modified 160 at the location of a water seepage site 135.

Several different objects may be found in an aerial image 100 of a target location 180. These objects include: an irrigation canal 170, a potential canal seepage site 150, vegetation, buildings, man-made objects, roads, etc. A water body may be an irrigation canal 170, seepage site, or non-seepage site. The location of a seepage site 135 is physically displayed two-dimensionally or three-dimensionally.

Aerial or geospatial images 100 may be acquired from an airplane or satellite in earth orbit using an image acquisition system 105, or by using a database such as Google Earth. The aerial image acquiring unit 105 may include a digital camera capable of capturing multispectral or hyperspectral single frame images. Alternatively, the aerial images 100 may be captured by other methods, for example, by conventional film aerial photography, where the pictures can be later scanned to create digital images.

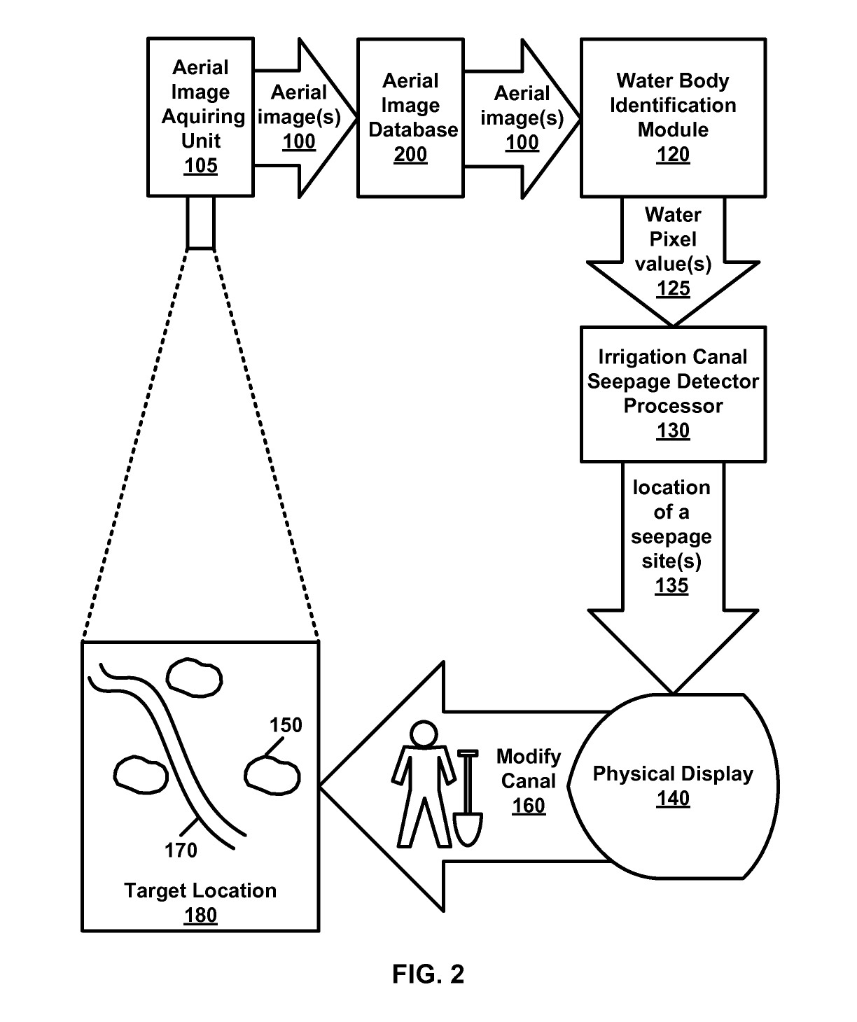

FIG. 2 is flow chart illustrating a second embodiment of an irrigation canal seepage detection system. Aerial images 100 of a target location 180 are obtained using an aerial image acquiring unit 105. The aerial image(s) 100 can be sent to and stored in an aerial image database 200. A water body identification module 120 can access the aerial image(s) from the aerial image database 200 and identify at least one water body. Water pixel brightness values 125 of a water body are then processed in an irrigation canal seepage detector processor 130. The irrigation canal seepage detector processor 130 then analyzes the pattern of the water pixel brightness values and reports the location of a seepage site 135 on a physical display 140. Finally, a segment or area of the canal is modified 160 at the location of a water seepage site 135.

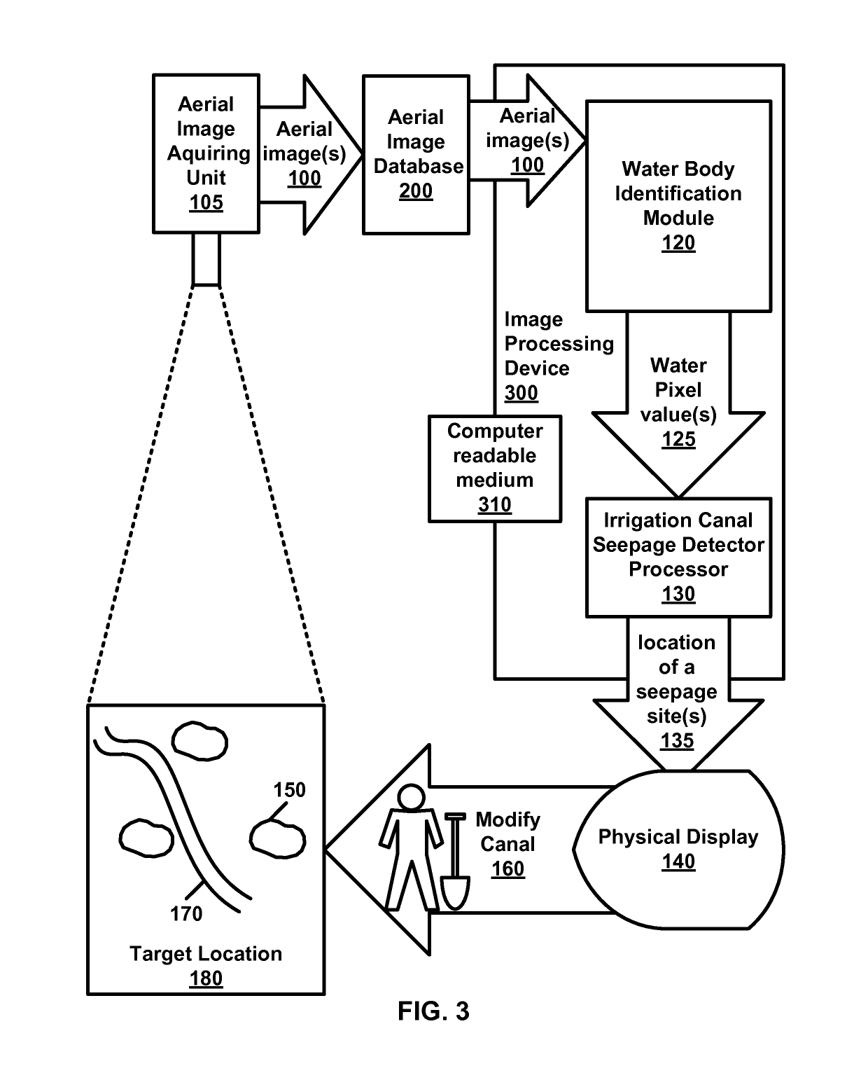

FIG. 3 is a flow chart illustrating a third embodiment of an irrigation canal seepage detection system executed under control of an image processing device. Aerial images 100 of a target location 180 are obtained using an aerial image acquiring unit 105. The aerial image(s) 100 can be sent to and stored in an aerial image database 200. At least one aerial image 100 is then accessed from an aerial image database 200. A water body identification module 120 within an image processing device 300 can access the aerial image(s) from the aerial image database 200 and identify at least one water body. The image processing device 300 processes aerial images. Any computer-readable storage medium 310 physically and tangibly embodying a program of instructions for detecting canal seepage is executable by the image processing device 300. As shown in FIG. 3, the image processing device 300 includes a water body identification module 120 and an irrigation canal seepage detector processor 130. That is, the image processing device 300 is configured as a system to include the water body identification module 120 and the irrigation canal seepage detector processor 130. The water body identification module 120 identifies at least one water body. Water pixel brightness values 125 of the water body are then processed in an irrigation canal seepage detector processor 130. The irrigation canal seepage detector processor 130 then analyzes the pattern of the water pixel brightness values and reports the location of a seepage site 135 on a physical display 140. Finally, a segment or area of the canal is modified 160 at the location of a water seepage site 135.

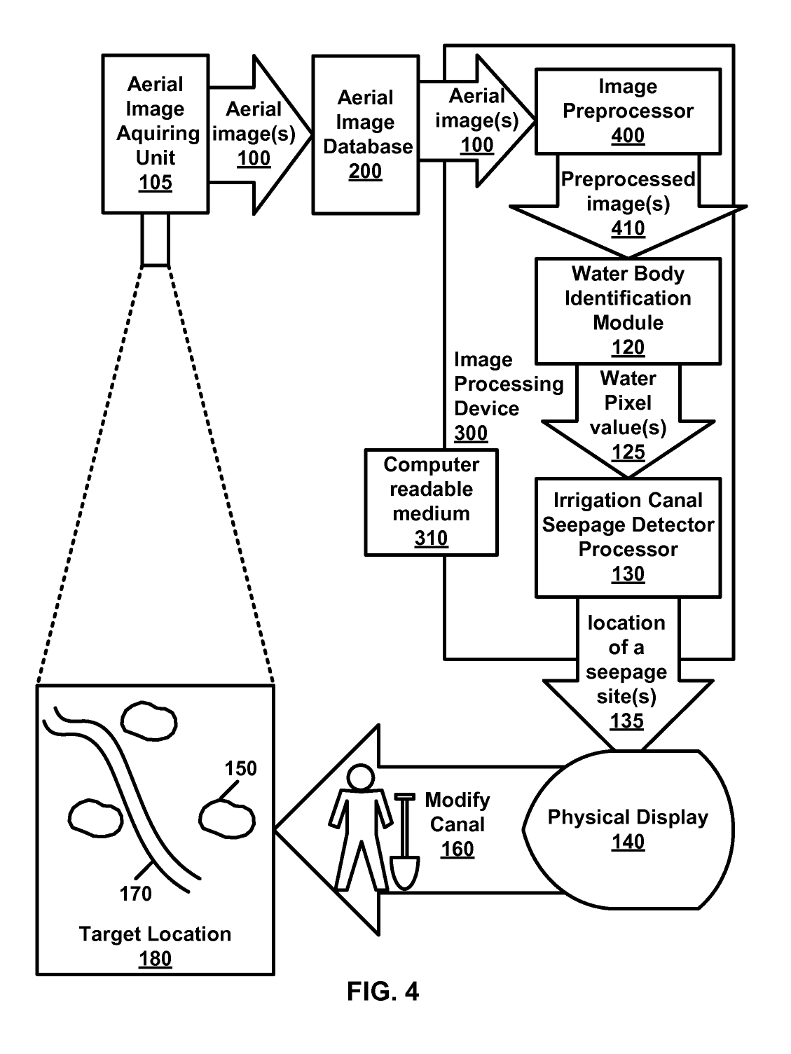

FIG. 4 is a flow chart illustrating a fourth embodiment of an irrigation canal seepage detection system executed under control of an image processing device. Aerial images 100 of a target location 180 are obtained using an aerial image acquiring unit 105. The aerial image(s) 100 can be sent to and stored in an aerial image database 200. At least one aerial image 100 is then accessed from an aerial image database 200. A water body identification module 120 within an image processing device 300 can access the aerial image(s) from the aerial image database 200 and identify at least one water body. Aerial images 100 are preprocessed in the image processing device 300 by using an image preprocessor 400. Any computer-readable storage medium 310 physically and tangibly embodying a program of instructions for detecting canal seepage is executable by the image processing device 300. As shown in FIG. 4, the image processing device 300 includes an image preprocessor 400, a water body identification module 120, and an irrigation canal seepage detector processor 130. That is, the image processing device 300 is configured as a system including the image preprocessor 400, the water body identification module 120, and the irrigation canal seepage detector processor 130. The image preprocessor 400 preprocesses at least one aerial image 100. The water body identification module 120 then identifies at least one water body from the preprocessed image 410. Water pixel brightness values 125 of the water body are then processed in an irrigation canal seepage detector processor 130. The irrigation canal seepage detector processor 130 then analyzes the pattern of the water pixel brightness values and reports the location of a seepage site 135 on a physical display 140. Finally, a segment or area of the canal is modified 160 at the location of a water seepage site 135.

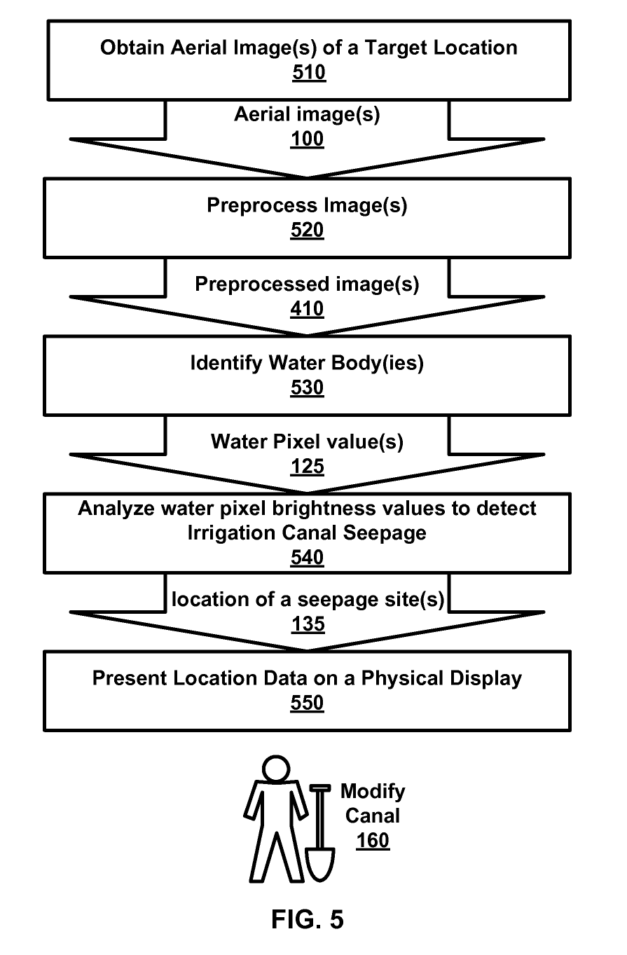

FIG. 5 is a flow chart illustrating an embodiment of a method for reducing irrigation canal seepage. Aerial images 100 are obtained of a target location 510. The aerial images 100 then undergo preprocessing 520. The preprocessed images 410 are used to identify a water body 530. Water pixel brightness values 125 from an identified water body 530 are then analyzed to detect irrigation canal seepage 540. After detecting the location of a seepage site 135, the location is presented on a physical display 550. Finally, a segment or area of the canal is modified 160 at the location of a water seepage site 135.

Remote sensing techniques offer extensive capability for rapid detection of seepage zones along a large length of canal systems. The remote sensing techniques may be suited where lateral seepage is predominant. For example, sites with a high water table, shallow impermeable layer, or bank seepage these environments represent conditions likely to facilitate lateral seepage and cause the seepage to have a surface expression.

Spaceborne or airborne remote sensing techniques can be successfully utilized as a cost effective means for assessing long sections of irrigation canals by evaluating wet areas (especially water bodies of reasonable sizes) adjacent to the canals for seepage or non-seepage sites, vegetation vigor, and soil profile properties.

There are various spaceborne and airborne sensors available on the market. Acquisition of MASTER (MODIS/ASTOR airborne simulator) data is one such tool to study seepage site detection. However, this is merely one embodiment since other tools exist in which the present invention may use.

MASTER is a 50-channel airborne imaging spectrometer (Hook et al., 2001) with 25 channels in the visible-near-infrared (VNIR) through shortwave-infrared (SWIR) bands (0.4-2.4 μm), 15 channels in the mid-infrared (MIR) bands (3.1-5.3 μm) and 10 channels in the thermal-infrared (TIR) bands (7.8-12.9 μm).

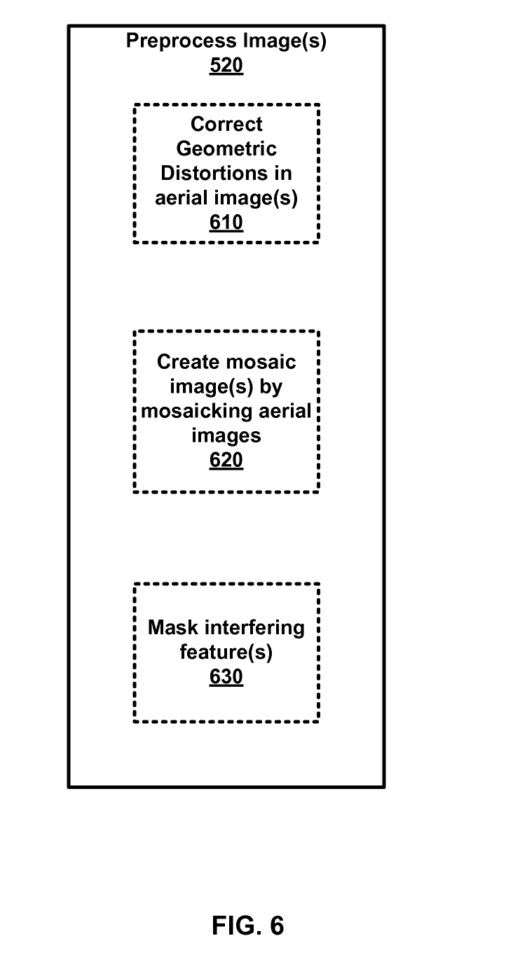

One again, referring to the figures, FIG. 6 shows a flow chart of the method illustrating possible actions that can be taken for preprocessing an image. Preprocessing an image 520 has three possible actions. First, the aerial image may be corrected for geometric distortion 610. Second, a mosaic image may be created by mosaicking the aerial images 620. Finally, interfering features may be masked 630 from the aerial image.

Geometric Distortion Correction

To successfully utilize an aerial multispectral image acquired through the sensor, the image geometric distortion may be properly rectified in the pre-processing phase. Accurate geometric distortion correction 610 may help in delineating canal segments, which may be present in various high spatial resolution scenes, and locating seepage sites in water related projects. To compensate for the airplane altitude change, the sensors can be placed on a gyro-stabilized platform. Remotely sensed distortion produced by changes in altitude (via air maneuvers such as roll, pitch, and yaw) are usually removed by identifying Ground Control Points (GCPs) in the original imagery and on the reference map and then mathematically modeling the geometric distortion. For missions where no navigation data are available, the distortion may be corrected through post acquisition image processing. For aerial image correction, GCPs may be used to reference images to geographic co-ordinates and or correct them to match base image geometry. For evaluation of the correction result, the corrected image may be first georeferenced to the UTM (Universal Transverse Mercator) projection with a group of GCPs. The GCPs may be uniformly spread throughout the region to be rectified to avoid being congested into one small area.

A general rule of thumb is to use a first-order affine polynomial whenever possible. Higher order polynomials (second-order or third-order) can be used where there is serious distortion in the dataset. A simple way to measure such distortion is to compute the RMSₑᵣᵣₒᵣ for each GCP by using the equation:

RMSₑᵣᵣₒᵣ=\sqrt{(x′−x_{orig})²+(y′−y_{orig})²} (1)

where x_{orig} and y_{orig} are the original row and column coordinates of the GCP in the image, and where x′ and y′ are the estimated coordinates in the original image. The square root of the squared deviations represents a measure of the accuracy of this GCP in the image. However, the digital processing time required to geometrically correct the remote sensing data using higher order polynomial increases because of the greater number of mathematical operations that may be performed.

Various methods of brightness value interpolation are available, such as nearest neighbor, bilinear interpolation, and cubic convolution. These interpolation techniques are usually known as resampling. The purpose of resampling is to extract and relocate the brightness values from x′, y′ location in the original distorted input image to the appropriate x, y co-ordinate location in the rectified output image.

Mosaicking

Mosaicking 620 relates to methods and systems for geometric alignment of overlapping digital images and, specifically, to a computer-implemented method of creating, from a set of component images, a single, seamless composite image of the entire area covered by the set of component images. In one embodiment, the method has particular applicability to vertical-viewing aerial imagery, but it can also be applied to other types of imagery.

Masking

In earth imaging operations, a set of aerial images is typically acquired from an airplane or satellite in earth orbit using an image acquisition system. The image acquisition system may include a digital camera capable of capturing multispectral or hyperspectral single frame images. Alternatively, the images may be captured by other methods, for example, by conventional film aerial photography, in which the photos taken may be later scanned to create digital images. Multispectral images comprise pixel intensity data in multiple spectral bands (e.g., red, green, blue, and NIR) with relatively broad bandwidth (25 to 150 nm), while hyperspectral images comprise data for a larger number of spectral bands (typically numbering in the hundreds) with a narrow bandwidth (typically 1 to 25 nm).

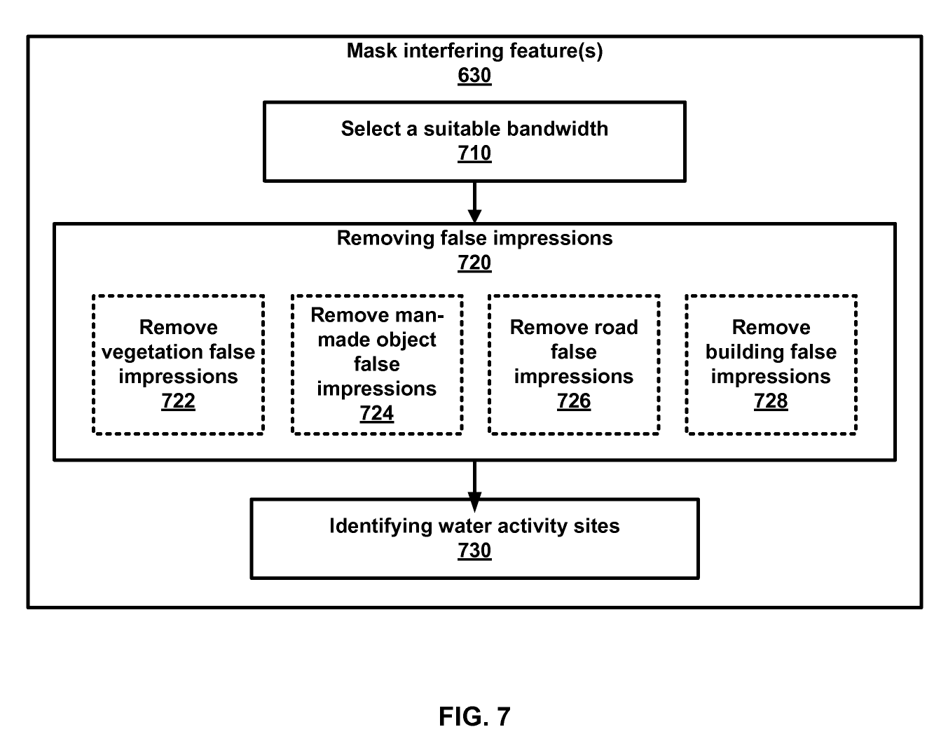

FIG. 7 is a flow chart of the method illustrating an embodiment for masking interfering features. First, to mask interfering features 630, a suitable bandwidth 710 is chosen. Second, geospatial techniques may be utilized to remove false impressions 720 of seepage or water activity sites. False impressions may include: natural vegetation 722, man-made objects 724, roads 726, and buildings 728. Removal of false impressions enormously improves the accuracy of the remote sensing technique for the identification of water activity sites 730. Remotely sensed data may be at a suitable resolution to allow definition of seepage zones. Typical seepage zones vary in size from a few centimeters to many meters in length adjacent to the irrigation canals. Therefore, high spatial and spectral resolution airborne sensors may play a role in improving the accuracy of capturing seepage or non-seepage sites on the imagery.

The regions of electromagnetic spectrum in the VNIR, SWIR, and TIR respond differently to different features on the ground. In one embodiment, a band from NIR region, a band from SWIR, and a band from TIR of the data can be used to assess the most suitable band for land-water separation of the image. Buildings respond better in the TIR bands due to higher heat radiation from rooftops compared to NIR-bands in which they tend to appear gray as they do not reflect the sun's energy strongly in this band. Vegetation appears lighter toned in the NIR bands due to strong reflection, and appears dark in the TIR bands due to strong absorption of light. Water appears dark due to substantial light absorption in all of the above band regions, thus creating a prominent land-water boundary in the image. However, water may respond better for land-water extraction in the NIR band. Vegetation can be eliminated better in the NIR band as it appears brighter, therefore, cannot be misinterpreted as a seepage site on multispectral imagery. Vegetation viewed through the TIR bands appear as suspected seepage sites. Thus, the use of NIR band for monitoring seepage or water activity sites is quite useful. In one embodiment, this band selection for contrast enhancement was augmented by applying the density slicing technique.

Band Selection

Water absorbs substantial light in the NIR, SWIR, and TIR wavelength regions creating a prominent land-water boundary in the image.

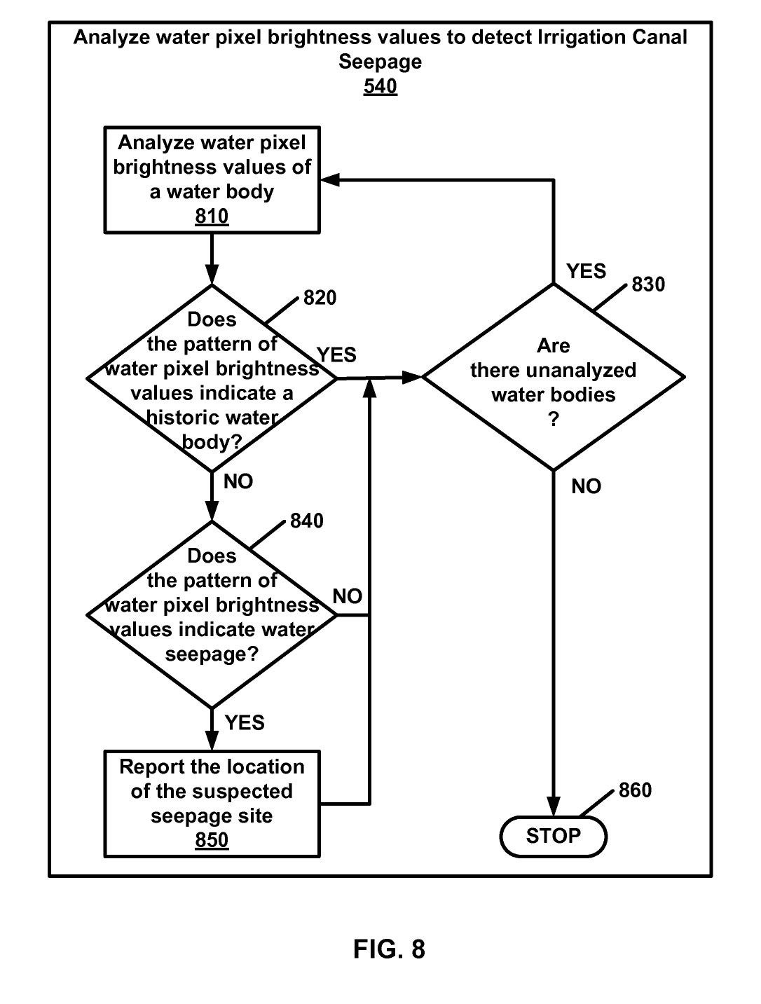

FIG. 8 is a flow chart of the method used to determine if the pattern of water pixel brightness values indicates a seepage or non-seepage site. This figure illustrates a method for analyzing water pixel brightness values to detect irrigation canal seepage 540. First, analyze water pixel brightness values of a water body 810. After analysis, the next step is determining whether the pattern of water pixel brightness values indicate a historic water body 820. If the answer to this step 820 is YES, then the next step is determining whether there are unanalyzed water bodies 830. If the answer to this step 830 is YES, then the analysis repeats at step 810. If the answer to this step 830 is NO, then the analysis stops 860. However, if the answer to step 820 is NO, then the next step is determining whether the pattern of water pixel brightness values indicate water seepage 840. If the answer to step 830 is NO, the analysis continues to step 830. However, if the answer to step 830 is YES, then the location of the suspected seepage site is reported at step 850 and the analysis continues with step 830.

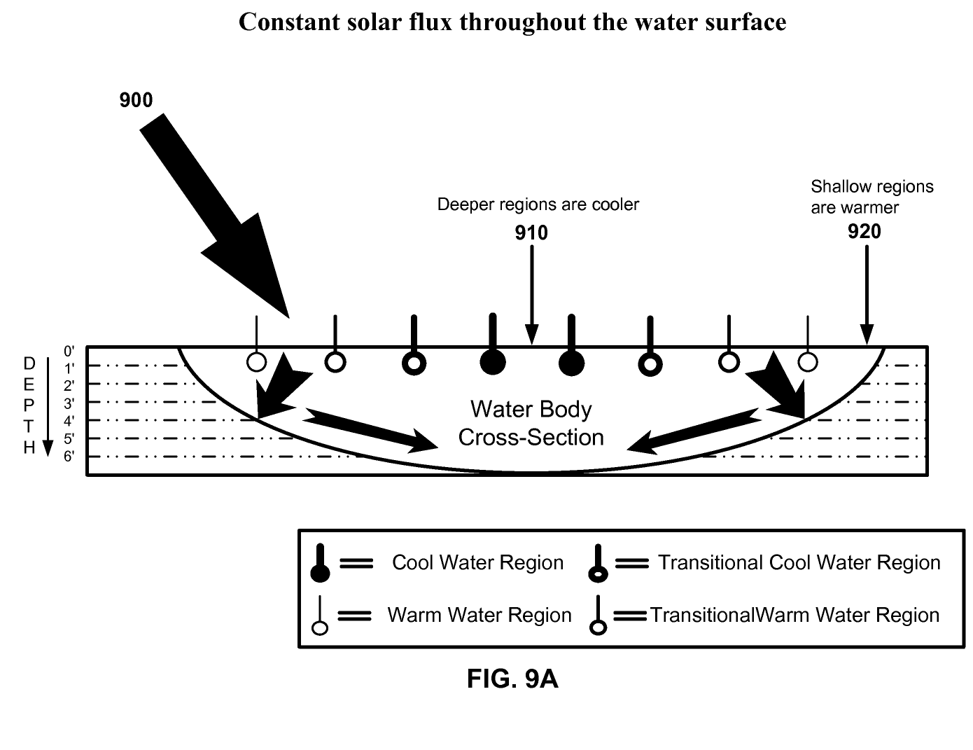

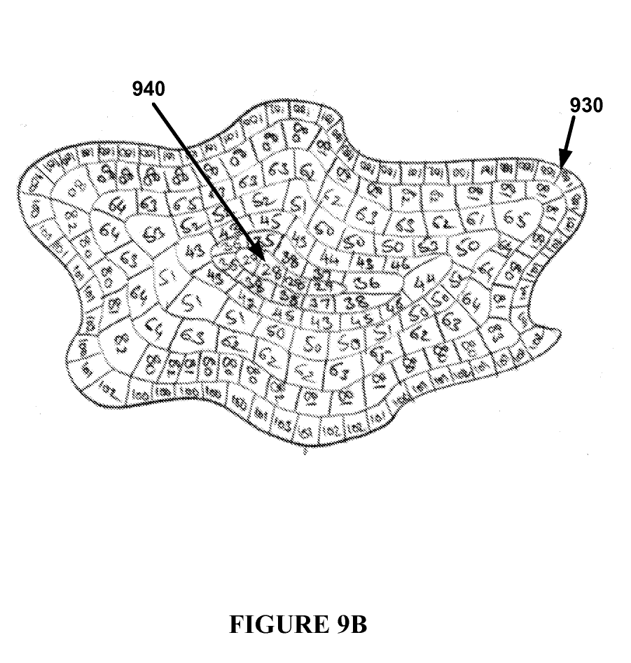

FIG. 9A illustrates a pattern of temperature gradients at non-seepage sites. Constant solar flux 900 throughout the water surface affects the temperature of the water region as a function of depth. For instance, deeper regions 910 are cooler, whereas shallow regions 920 are warmer. A pattern of continuous temperature rise for all water regions generally occurs more for shallow regions and less for deeper regions at or about the same rate of solar influx 900.

FIG. 9B is an example schematic of brightness values for non-seepage sites. The pattern of water pixels in the shallow region 930 of historical water bodies exhibit higher brightness values due to increasing energy of water molecules (diurnal cycle), while the pattern of water pixels towards the deeper middle region 940 of the water bodies exhibit lower brightness values.

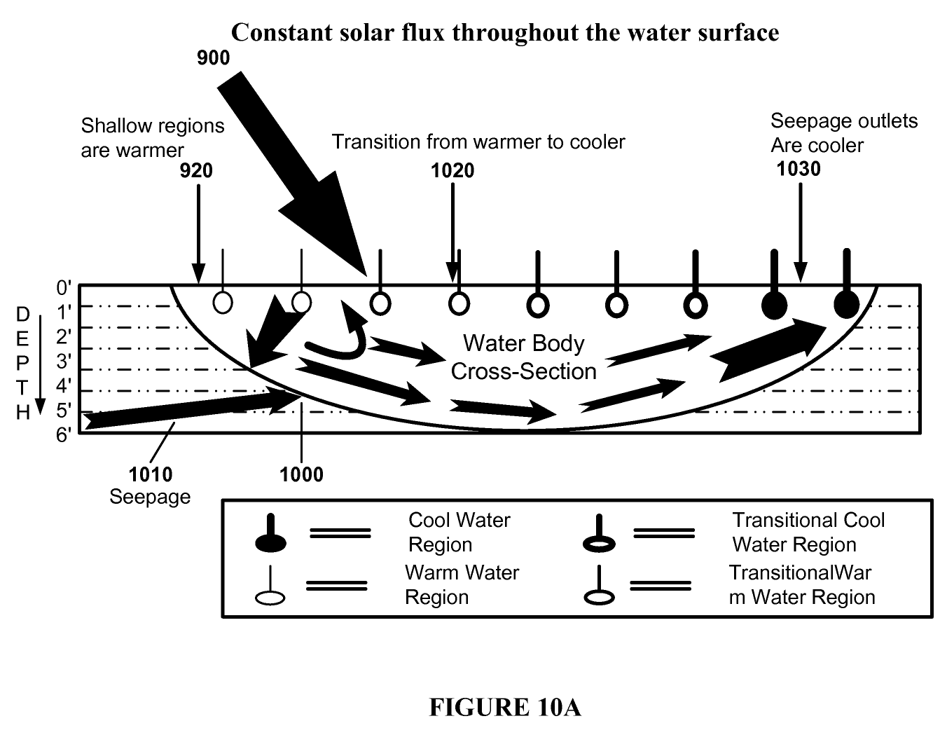

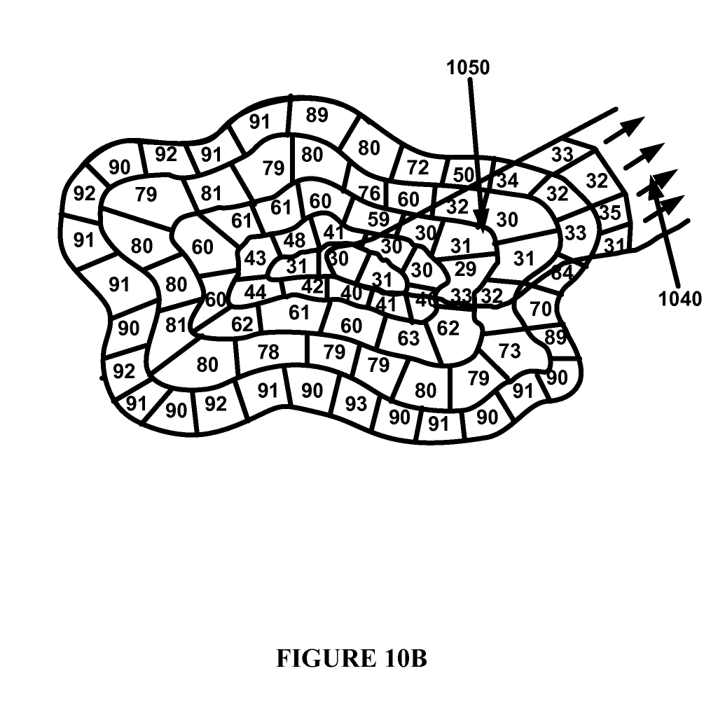

FIG. 10A is an example schematic of temperature gradients at seepage sites. Here, the seepage point 1000 is flowing towards the left bottom of the water body while seepage water 1010 is flowing towards the right side due to a lower level of surrounding land. Water in the shallow outer region 920 of the water body (except where the water is leaving) represents higher brightness values due to thermal eddies formation as a result of continuous reception of solar energy 900. The figure also illustrates the transitioning of water temperatures from warmer to cooler 1020. Generally, seepage outlets tend to be cooler 1030.

FIG. 10B is an example schematic of brightness values for seepage sites. Where the water is leaving 1040, the brightness values of the water pixels 1050 are low due to path followed by seepage water inflow from the canal. The study of pattern variation of water pixels for the same solar influx 900 may be used to discriminate seepage sites from non-seepage sites.

During the hottest time of the diurnal energy cycle, water bodies with no seepage show high brightness pixel values in shallow regions 920 and low brightness pixel values towards deeper regions 910. In contrast, water bodies with seepage from canals show a strong variation in brightness values of water pixels. Depending on the seepage flow rate, the path traversed by seepage water 1010 will tend to have cooler pixel values 1050.

The preferable conditions for seepage detection are reasonable seepage flow rates with dry weather, sunny skies, and low relative humidity between about 2:00 PM to 4:00 PM in early spring time. In other embodiments, summer, fall, or winter seasons could be used to detect canal seepage. In yet other embodiments, detecting canal seepage can occur during any daylight hour. In yet another embodiment, detection can be observed during the night.

Discriminating water seepage from non-seepage sites along irrigation canals based on formation of thermal gradients or eddy formation in water bodies is based on principles of heat transfer. Seepage sites (FIG. 10B) have a characteristic pattern of water pixel brightness values (BV's) that are different from non-seepage sites (FIG. 9B) for the same amount of incident solar flux. This difference may even be observed during the night. Water has high thermal capacity. Because of this property, water slowly releases energy as compared to its surroundings.

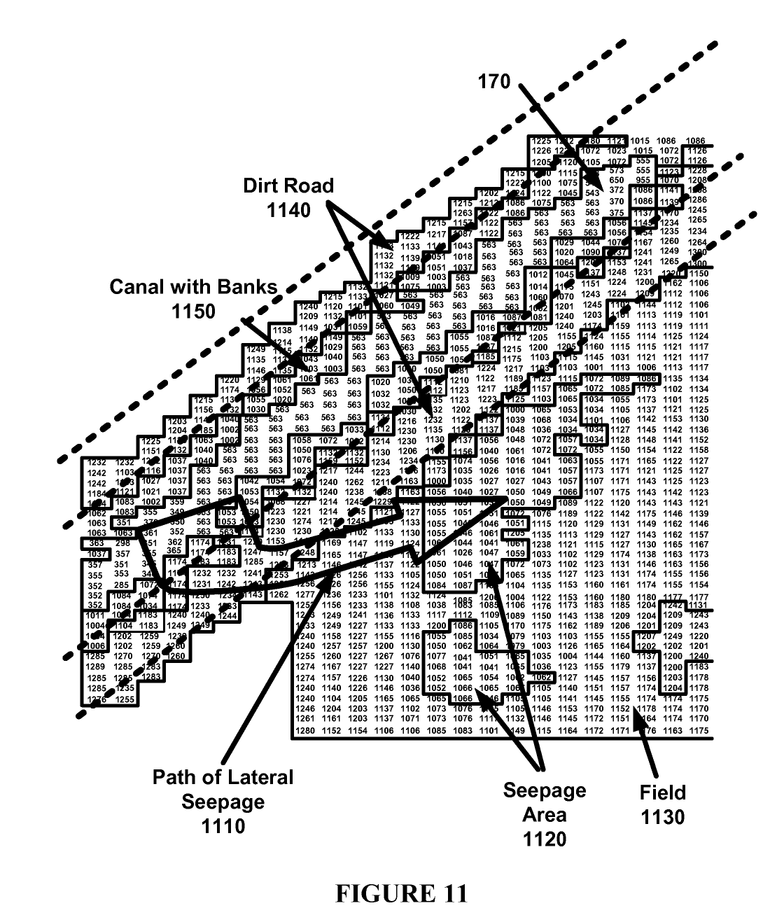

FIG. 11 is a set of aerial data that shows seepage or a canal breach in brightness values. Analysis of the region of interest (ROI), in terms of brightness and radiance values show that this area was either breached or overflowed due to heavy down pouring before the aerial image was captured. The canal 170 has a path of lateral seepage 1110, flowing towards the right which accumulates in the seepage area 1120. The brightness values of the pixels vary depending on the object. The field 1130 has a different brightness value than the dirt road 1140 or the canal with banks 1150.

In this specification, “a”, “an”, and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital, and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages, such as assembly, C, C++ or the like. FPGAs, ASICs, and CPLDs are often programmed using hardware description languages (HDL), such as VHSIC hardware description language (VHDL) or Verilog, which can configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

What is claimed is:

1. A method of reducing irrigation canal seepage, comprising:
a. obtaining aerial data of an irrigation canal obtained with the use of an aerial image acquiring unit, at least some of the aerial data including at least one aerial image, the at least one aerial image including pixel brightness values;
b. identifying at least one water body captured in the aerial data;
c. analyzing the water pixel brightness values of the at least one water body to discern water disturbances that are indicative of water seepage; and
d. outputting, on a two-dimensional or three-dimensional display, the location of at least one of the at least one water body if the at least one of the at least one water body was determined to have a water disturbance that is indicative of water seepage.

2. The method of claim 1, further comprising modifying an area of the canal where water seepage is identified.

3. The method of claim 1, further comprising:
a. correcting the aerial data using a geometric distortion processor; and
b. mosaicking a set of the at least one aerial image, the set including at least a first image and a second image, the first image having an overlapping area that overlaps the second image.

4. The method of claim 3, further including masking the aerial image to remove at least one interfering feature.

5. The method of claim 4, wherein the masking further comprises removing a first class of false impressions by limiting the at least one aerial image to a first predetermined bandwidth.

6. The method of claim 5, wherein the first class of false impressions include vegetation.

7. The method of claim 4, wherein the masking further comprises removing a second class of false impressions by limiting the at least one aerial image to a second predetermined bandwidth.

8. The method of claim 7, wherein the second class of false impressions include one or a combination of the following:
a. man-made objects;
b. roads; and
c. buildings.

9. The method of claim 1, wherein the identifying at least one water body captured in the aerial data includes using at least one seepage processor to discriminate differences between seepage sites and non-seepage sites.

10. The method of claim 1, wherein the analyzing water pixel brightness values of the at least one water body to discern water disturbances indicative of water seepage includes analyzing with at least one analyzing processor seepage sites and non-seepage sites.

11. An irrigation canal seepage detection system, comprising:
a. at least one aerial image acquiring unit configured to form at least one aerial image of the canal using at least one predetermined bandwidth, the at least one aerial image including at least one water pixel brightness value;
b. at least one water body identification module configured to detect the location of at least one water body; and
c. at least one irrigation canal seepage detection processor configured to detect irrigation canal seepage by analyzing water pixel brightness values of the at least one water body to discern water disturbances indicative of water seepage.

12. The system of claim 11, further including a data preprocessing module, the data preprocessing module configured to:
a. correct geometric distortions in at least one of the at least one aerial image; and
b. create at least one mosaic image by mosaicking a set of the at least one aerial image, the set including at least a first image and a second image, the first image having an overlapping area that overlaps the second image.

13. The system of claim 12, further including an interfering feature module configured to mask at least one interfering feature.

14. The system of claim 11, wherein the predetermined bandwidth is selected to minimize the effect of at least one or a combination of the following on the at least one aerial image:
a. vegetation;
b. man-made objects;
c. roads; and
d. buildings.

15. The system of claim 11, wherein the at least one aerial image acquiring unit acquires images from at least one online aerial image database.

16. The system of claim 15, wherein the online aerial image database is Google Earth.

17. The system of claim 13, wherein the aerial image acquiring unit is attached onto at least one air vehicle.

18. The system of claim 13, wherein the irrigation canal seepage detection processor compares the aerial image to at least one reference image stored in a database, wherein the reference image is substantially optically equivalent to the image of the canal.

19. The system of claim 18, wherein the reference image comprises designations identifying seepage sites and non-seepage sites of the canal, and wherein the irrigation canal seepage detection processor is further configured to indicate where the seepage sites are located.

20. A computer-readable storage medium tangibly embodying a program of instructions executable by a computer to perform a method of reducing irrigation canal seepage, the method comprising:
a. obtaining aerial data of an irrigation canal obtained by using an aerial image acquiring unit, at least some of the aerial data including at least one aerial image, the aerial image including pixel brightness values;
b. preprocessing the aerial data by using a geometric distortion processor;
c. using at least one identification module to identify at least one water body captured in the aerial data;
d. analyzing, with at least one irrigation canal seepage processor, water pixel brightness values of the water body to discern water disturbances indicative of water seepage; and
e. outputting, on a display, the location of at least one of the water body if the water body is determined to have a water disturbance indicative of water seepage.
